(19) United States
(12) Patent Application Publication
(10) Pub. No.: US 2025/0259193 A1
(43) Pub. Date: Aug. 14, 2025

(54) SYSTEM AND METHOD TO GENERATE EXTENDED CONTEXT DERIVED FROM CONSUMER RESPONSES

(71) Applicant: Toyota Research Institute, Inc., Los Altos, CA (US)

(72) Inventors: Ryosuke Nakanishi, San Jose, CA (US); Yin-Ying Chen, San Jose, CA (US); Shabnam Hakimi, San Francisco, CA (US); Matthew K. Hong, Mountain View, CA (US); Matthew E. Klenk, San Francisco, CA (US)

(73) Assignees: Toyota Research Institute, Inc., Los Altos, CA (US); Toyota Jidosha Kabushiki Kaisha, Aichi-ken (JP)

(21) Appl. No.: 18/441,035

(22) Filed: Feb. 14, 2024

(51) Int. Cl. G06Q 30/0203; G06F 16/33; G06Q 30/0204

(52) U.S. Cl. CPC G06Q 30/0203; G06F 16/3344; G06Q 30/0204

(57) ABSTRACT

A method may include receiving a plurality of consumer text responses, determining labels for one or more of the consumer text responses, determining one or more text segments of each of the consumer text responses, generating an embedding of each of the text segments, generating a graph comprising a first set of nodes comprising latent components based on the embedding of each of the text segments, a second set of nodes comprising the consumer text responses, and a plurality of edges between the first set of nodes and the second set of nodes, initializing weights of edges between the first set of nodes and the second set of nodes based on the embedding of each of the text segments, and using a graph neural network to learn updated weights of the edges based on a predetermined objective.

### FIELD

The present specification generally relates to analyzing responses to consumer surveys and, more specifically, to a system and method to generate extended context derived from consumer responses.

### BACKGROUND

Businesses often receive consumer text responses from their customers. These responses may include comments about products used by the consumers. The businesses that receive these responses may use them to gain insights into how the products are being used and enjoyed by customers. As such, businesses may rely on these responses when making marketing decisions, when designing future products, or when changing existing products.

However, when receiving large amounts of consumer text responses, it may be impractical for humans to individually review each response. As such, it may be desirable to use automated tools to review consumer text responses and determine important information and relationships therefrom. Thus, there is a need for a system and method to generate extended context derived from consumer responses.

### SUMMARY

In an embodiment, a method may include receiving a plurality of consumer text responses, determining labels for one or more of the consumer text responses, determining one or more text segments of each of the consumer text responses, generating an embedding of each of the text segments, generating a graph comprising a first set of nodes comprising latent components based on the embedding of each of the text segments, a second set of nodes comprising the consumer text responses, and a plurality of edges between the first set of nodes and the second set of nodes, initializing weights of edges between the first set of nodes and the second set of nodes based on the embedding of each of the text segments, and using a graph neural network to learn updated weights of the edges based on a predetermined objective.

In another embodiment, an apparatus may include a processor configured to receive a plurality of consumer text responses, determine labels for one or more of the consumer text responses, determine one or more text segments of each of the consumer text responses, generate an embedding of each of the text segments, generate a graph comprising a first set of nodes comprising latent components based on the embedding of each of the text segments, a second set of nodes comprising the consumer text responses, and a plurality of edges between the first set of nodes and the second set of nodes, initialize weights of edges between the first set of nodes and the second set of nodes based on the embedding of each of the text segments, and use a graph neural network to learn updated weights of the edges based on a predetermined objective.

These and other features, and characteristics of the present technology, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network to generate extended context derived from consumer responses, according to one or more embodiments shown and described herein;

FIG. 2 schematically depicts the server computing device from FIG. 1, according to one or more embodiments shown and described herein;

FIG. 3 depicts an example consumer text response, according to one or more embodiments shown and described herein;

FIG. 4 depicts an example graph, according to one or more embodiments shown herein;

FIG. 5 depicts example weights of a portion of the graph of FIG. 4, according to one or more embodiments shown herein; and

FIG. 6 depicts a flow diagram of an illustrative method that may be performed by the computing network of FIG. 1, according to one or more embodiments shown and described herein; and

### DETAILED DESCRIPTION

Referring generally to the figures, embodiments described herein are directed to a system and method to generate extended context derived from consumer responses. In embodiments disclosed herein, consumer text responses may be received from a large number of consumers. For example, a product manufacturer may send out surveys to consumers who have purchased a certain product. The surveys may ask questions about the consumers' experience using the product. In particular, the surveys may allow the consumers to provide a free form text response about the product or their use thereof. That is, each consumer may provide an unstructured text response to the survey.

Because the consumer text responses may comprise of free form, unstructured text, automated analysis may be challenging. Accordingly, in embodiments discloses herein, natural language processing (NLP) techniques are used to determine one or more text segments of each received consumer text response. In particular, NLP techniques may be used to determine causes, effects, and needs specified in a consumer text response based on the linguistic structure of the consumer text response.

After the text segments of a consumer text response are identified, each of the identified text segments may be vectorized using NLP techniques to determine an embedding of each text segment. The embeddings from each consumer text response may then be input into a graph. In particular, the embeddings of the text segments may comprise a first set of nodes, and the consumer text responses may comprise a second set of nodes. In some examples, additional information such as demographic information about the consumers or product attributes associated with the consumer text responses may comprise additional nodes.

The text responses may also be labeled. In one example, the text responses may include a numerical rating. For example, consumers may include a rating from 1 to 10 based on their satisfaction with the product. In another example, an expert may review some of the text responses and categorize them based on certain criteria.

The graph is then initialized with edges between the first set of nodes and the second set of nodes. In particular, the edges may be assigned weights based on the text segments identified in each consumer text response. The graph may then be input into a graph neural network, which may learn updated weights of the edges in order to optimize an objective (e.g., predicting a numerical rating based on the causes, effects, and needs included in a text response). After the graph neural network updates the weights, the updated weights may be used to identify particular causes, effects, and needs most associated with a particular objective. Accordingly, a business that received the consumer text responses may focus product development or marketing efforts on the identified causes, effects, and needs.

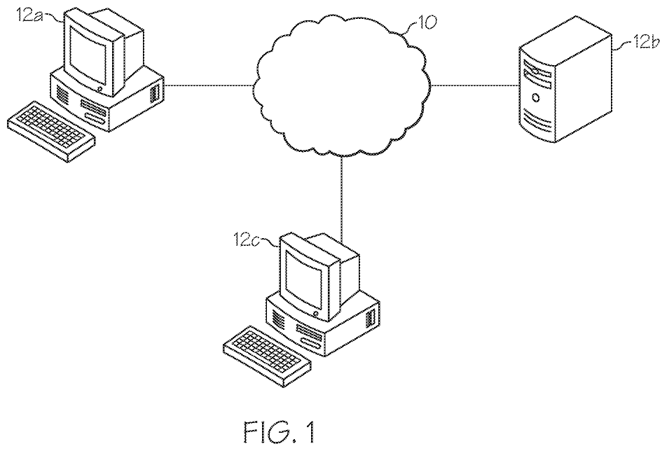

Referring now to the drawings, FIG. 1 depicts an illustrative computing network, illustrating components of a system for performing the functions described herein, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to facilitate retrieving or inputting consumer text responses for analysis, as disclosed herein. For example, the user computing device 12a may be a personal computer that a user utilizes to retrieve consumer text responses from a database, manually input the content of consumer text responses, scan consumer text responses, or otherwise input or retrieve consumer text responses. After the consumer text responses are received by the user computing device 12a, the user computing device 12a or the server computing device 12b may perform the techniques disclosed herein to generate extended context derived from the consumer text responses. In some examples, the user computing device 12a may be a tablet, a smartphone, a smart watch, or any other type of computing device used by a user to receive information.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction.

The server computing device 12b may receive consumer text responses input to the user computing device 12a and determine extended context, using the techniques described herein. The server computing device 12b may then transmit information to be displayed by the user computing device 12a based on the results of performing the disclosed techniques. In some examples, the server computing device 12b may be removed from the system of FIG. 1 and may be replaced by a software application on the user computing device 12a. For example, the functions of the server computing device 12b may be performed by a software application or browser plugin on the user computing device 12a. The components and functionality of the server computing device 12b will be set forth in detail below.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, the server computing device 12b, and the administrator computing device 12c may represent a plurality of computers, servers, databases, etc.

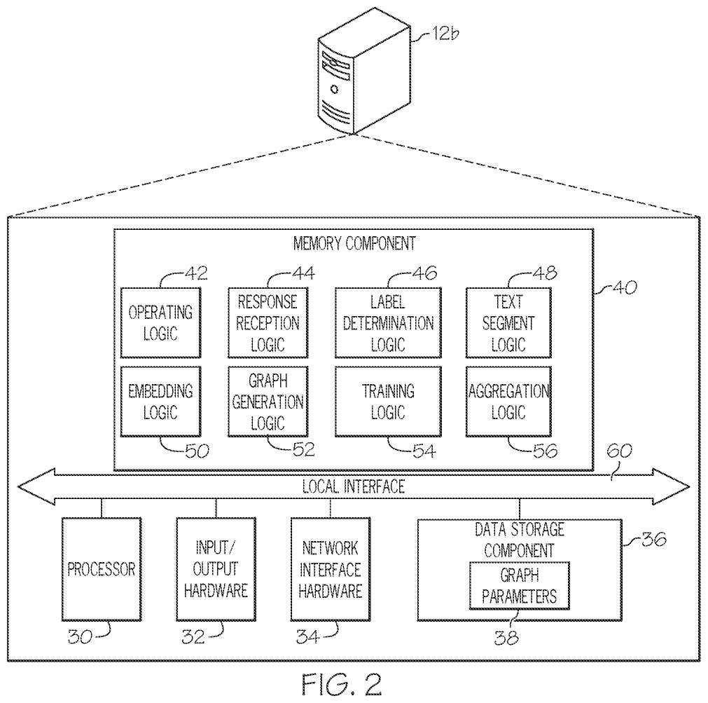

FIG. 2 depicts additional details regarding the server computing device 12b from FIG. 1. While in some embodiments, the server computing device 12b may be configured as a general purpose computer with the requisite hardware, software, and/or firmware, in some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store graph parameters 38), and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, response reception logic 44, label determination logic 46, text segment logic 48, embedding logic 50, graph generation logic 52, training logic 54, and aggregation logic 56 (each of which may be embodied as a computer program, firmware, or hardware, as an example). A local interface 60 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store graph parameters 38, described in further detail below.

Included in the memory component 40 are the operating logic 42, the response reception logic 44, the label determination logic 46, the text segment logic 48, the embedding logic 50, the graph generation logic 52, the training logic 54, and the aggregation logic 56. The operating logic 42 may include an operating system and/or other software for managing components of the server computing device 12b.

The response reception logic 44 may receive consumer text responses, as disclosed herein. As discussed above, a business may send surveys to a plurality of consumers that have purchased or used a particular product. In embodiments, consumers may respond to the surveys by providing a text response. In some examples, the text response may indicate problems with the product. In some examples, the consumer text response may also include other information such as a particular model of the product purchased by the consumer and/or demographic information of the consumer.

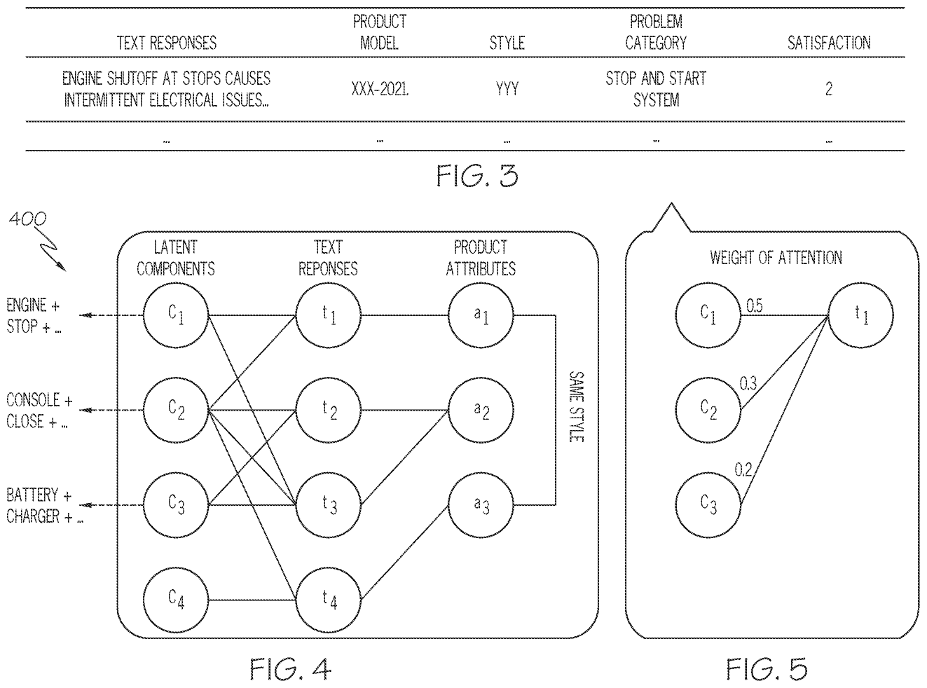

FIG. 3 shows an example text response provided by a consumer. In the example of FIG. 3, the response is related to the use of the vehicle and the text response comprises “Engine shutoff at stops causes intermittent electrical issues”. The response of FIG. 3 also indicates a product model of “XXX-201” and a style of “YYY”. These may be selected by the consumer when filling out the survey in order to provide more detailed information (e.g., by checking boxes on a paper survey or selecting options from a drop down menu on a web page).

In the example of FIG. 3, the response also indicates a problem category and a satisfaction that may be used as labels, as discussed in further detail below. In the example of FIG. 3, the indicated satisfaction is 2, which may be selected by the consumer filling out the survey. For example, the survey may ask the consumer to rate their satisfaction with the product on a scale from 1-10. However, it should be understood that this is merely one example, and in other examples, the consumer may indicate a level of satisfaction using any other scale. In some examples, consumer text responses may not include a satisfaction or a problem category.

In the example of FIG. 3, the problem category is indicated as “Stop and Start System”. In some examples, this may be selected by the consumer filling out the survey. For example, a drop down menu may provide a number of options for the consumer to select. In other examples, an expert may screen the consumer text response and determine the problem category. In these examples, the expert may review a small number of consumer text responses and determine the problem category for each consumer text response reviewed based on the content of the consumer text response and the expertise and experience of the expert. The problem categories identified by the expert for the consumer text responses reviewed may then be used as labels to determine the problem category for a larger number of consumer text responses, as disclosed in further detail below.

Referring back to FIG. 2, the response reception logic 44 may receive all of the consumer text responses that are responsive to a survey related to a particular product. For example, consumers may be sent a link to fill out the survey on-line, and after each response is submitted, it may be added to a database that stores all of the survey results. The response reception logic 44 may then retrieve all of the responses from the database. However, it should be understood that in other examples, consumers may response to the survey in other ways. For example, paper responses may be scanned or a user may manually enter survey results into the user computing device 12a.

Referring still to FIG. 2, the label determination logic 46 may determine a label for one or more of the consumer text responses received by the response reception logic 44. As discussed above, a graph neural network may be used to learn the weights of edges a graph that optimizes a predetermined objective. As such, the label determination logic 46 may determine labels for one or more of the consumer text responses based on the predetermined objective. For example, if the predetermined objective is to maximize a numerical rating (e.g., the satisfaction in the example of FIG. 3), then the label determination logic 46 may determine a numerical rating as a label for each of the consumer text responses. For example, the label determination logic 46 may extract the specified satisfaction value from each of the consumer text responses as a label. In other example, if the predetermined objective is determining product categorization, then the label determination logic 46 may extract the problem category, either specified by the consumer or determined by an expert, as a label for each of the consumer text responses.

In some examples, the label determination logic 46 may determine a label for all of the consumer text responses received by the response reception logic 44. However, in other examples, the label determination logic 46 may only determine a label for some of the received consumer text responses. For example, for a particular survey, it may be the case that only some of the respondents indicate a numerical satisfaction rating. In that case, the label determination logic 46 may use the provided ratings to generate labels for the associated consumer text responses, and the satisfaction rating for the other responses may be predicted, as disclosed in further detail below. In another example, as discussed above, an expert may determine product category labels for a small subset of the consumer text responses received by the response reception logic 44 and product categories for the other consumer text responses may be predicted using the techniques disclosed herein.

Referring still to FIG. 2, the text segment logic 48 may determine one or more text segments of each of the consumer text responses received by the response reception logic 44. In one example, the text segment logic 48 may utilize natural language processing techniques to identify different text segments of each received consumer text response. In particular, natural language processing techniques may allow the text segment logic 48 to identify different text segments of a consumer text response based on the linguistic structure of the text. For example, the text segment logic 48 may use a natural language processing kit such as Natural Language Toolkit (NLTK) to identify different text segments of a consumer text response based on a syntactic structure of the consumer text response. However, it should be understood that in other examples, the text segment logic 48 may use other types of natural language processing techniques.

In the illustrated example, the text segment logic 48 may determine different text segments of a consumer text response comprising one or more of causes, effects, and needs. However, in other examples, the text segment logic 48 may identify other types of text segments. In some examples, a consumer text response may not contain each of a cause, an effect, and a need. In these examples, the text segment logic 48 may identify whichever text segments are present in a consumer text response.

In the example of FIG. 3, the text response “Engine shutoff at stops causes intermittent electrical issues” may be broken up into two text segments comprising a cause and an effect. The cause may be “engine shutoff at stops” and the effect may be “intermittent electrical issues”. The consumer text response in the example of FIG. 3 does not have a needs text segment. In the example of FIG. 3, the text segment logic 48 may identify the cause and effect text segments based on the present of the word “causes” in the response. In other examples, the text segment logic 48 may identify text segments based on other words, phrases, punctuation marks, and other linguistic elements. In some examples, the text segment logic 48 may utilize a natural language processing model trained a large corpus of text data with appropriate labels.

Referring back to FIG. 2, the embedding logic 50 may map each of the text segments identified by the text segment logic 48 into a latent space. In particular, the embedding logic 50 may determine an embedding of each the text segments of a consumer text response identified by the text segment logic 48. Word embedding is a technique of mapping a word or phrase into a vector of real numbers. Once a word or phrase has been translated into a vector representation, it may be mathematically compared to other words or phrases using their vector representations. In particular, a distance between the vector representations of two words or phrases (e.g., using cosine similarity) may indicate a semantic similarity between the words or phrases.

Word embedding typically involves training a neural network on a large corpus of text to create a multi-dimensional vector space with each word in the corpus having a vector representation. Words that share similar contexts are located close to each other in the vector space. Once the neural network is trained, any word or phrase may be input into the word embedding model to get its vector representation.

In embodiments, the embedding logic 50 may utilize a word embedding model to determine a vector representation of each identified text segment. In some examples, the embedding logic 50 may use Word2vec or Bidirectional Encoder Representations from Transformers (BERT) to determine a vector representation of the identified text segments. However, in other examples, other word embedding models may be used.

Referring still to FIG. 2, the graph generation logic 52 may generate a graph, as disclosed herein. The graph generated by the graph generation logic 52 ay have a plurality of nodes connected by a plurality of edges. Each of the edges may have a weight, as discussed in further detail below.

In embodiments, a first set of nodes may comprise latent components based on the embeddings of the text segments determined by the embedding logic 50. A second set of nodes may comprise the consumer text responses received by the response reception logic 44. In some examples, additional sets of nodes may comprise product attributes, demographic information, or other data based on the consumer text responses.

FIG. 4 illustrates an example graph 400 that may be generated by the graph generation logic 52. In the example of FIG. 4, the graph 400 includes three sets of nodes, a first set of nodes c1-c4 comprising latent components, a second set of nodes t1-t4 comprising consumer text responses, and a third set of nodes a1-a3 comprising product attributes. In other examples, a graph may include additional sets of nodes with demographic or other information.

In the example of FIG. 4, the graph 400 is based on four text responses, which are stored as nodes t1-t4. The text segment logic 48 may determine one or more text segments for each consumer text response and the embedding logic 50 may determine an embedding for each text segment, as discussed above. The nodes c1-c4 may comprise latent components based on the embeddings of the text responses. The nodes a1-a3 may comprise product attributes indicated by the text responses.

In the example of FIG. 4, the node c1 may comprise a vector representation of “engine” and “stop”, the node c2 may comprise a vector representation of “console” and “close”, and the node c3 may comprise a vector representation of “battery” and “charger”. The node c4 may contain a vector representation of other information. As shown in FIG. 4, node t is connected two nodes c1 and c2. This indicates that the text response associated with node t1 includes a text segment related to “engine” and “stop” and also a text segment related to “console” and “close”. The node t1 is also connected to node a1 indicating that the text response associated with node t1 has product attributes indicated by node a1. Similarly, node t2 is connected to nodes c2 and c3, and node a2. Node t3 is connected to nodes c1 and c2, and node a2. Node t4 is connected to nodes c2 and c4, and node a3.

In embodiments, the graph generation logic 52 may generate one node for each text response and one node for each embedding of a text segment (e.g., a vector representation of the text segment). In some examples, the graph generation logic 52 may also generate one node for each product attribute, as shown in FIG. 4. In some examples, the graph generation logic 52 may also generate one node for each piece of demographic information identified in a consumer text response (e.g., age, gender, and the like). In some examples, some nodes may represent embeddings of causes identified in consumer text responses, some nodes may represent embeddings of effects identified in consumer text responses, and some nodes may represent embeddings of needs identified in consumer text responses.

If multiple consumer text responses have a text segment with the same embedding, the graph generation logic 52 only creates a single node with that embedding. Then, every consumer text response containing that text segment may be connected to that node with an edge. However, in some examples, different consumer text responses may contain text segments that are similar, but not exactly the same. For example, one text response may say that the vehicle slows down and another text response may say that the vehicle decelerates. These two text segments may have slightly different embeddings. However, it may be desirable to consider them as the same so that a single node may be created and each of the two text responses may be connected to the node. Accordingly, in some examples, the graph generation logic 52 may perform cluster analysis when generating the nodes for the embeddings of text segments, as disclosed herein.

In embodiments, the embedding logic 50 may determine an embedding (e.g., a vector representation) of each text segment identified by the text segment logic 48. The graph generation logic 52 may then perform cluster analysis of each embedding. That is, the graph generation logic 52 may determine a similarity between each embedding (e.g., a cosine similarity). The graph generation logic 52 may then identify one or more cluster, wherein each cluster comprises embeddings that have greater than a threshold similarity (or less than a threshold distance) to each other. The graph generation logic 52 may then generate one node for each cluster. As such, each identified text segment that is sufficiently similar to other text segments will all be identified as the same node having the same embedding.

After generating the nodes of the graph, the graph generation logic 52 may initialize weights of edges between the nodes of the graph. In particular, the graph generation logic 52 may generate edges between the text response nodes and the latent component nodes. The graph generation logic 52 may also generate edges between the text response nodes and other nodes such as nodes indicating product attributes or demographic information. In one example, for each text response containing a particular text segment, the graph generation logic 52 may initialize an edge between the text segment node and the latent component node associated with the text segment with a weight of 1. Similarly, edges between text responses and latent component nodes associated with text segments not in the text response may be initialized with a weight of 0.

For example, in FIG. 4, edges are shown between node t1 and nodes c1 and c2, indicating that the embeddings associated with nodes c1 and c2 are associated with text segments included in the text response associated with node t1. In FIG. 4, there are no edges shown between node t1 and nodes c3 and c4. However, the graph generation logic 52 may initialize weights of 0 between these nodes. In addition, the graph generation logic 52 may initialize a weight of 1 between the edge connecting node t1 and node a1, and a weight of 0 connecting node t1 and nodes a2 and a3. The parameters of the graph, including the nodes and the initialized weights may be stored as graph parameters 38 of the data storage component 36.

Referring back to FIG. 2, the training logic 54 may utilize a graph neural network to learn updated weights between the edges of the graph initialized by the graph generation logic 52. In particular, the graph neural network may learn updated weights based on a predetermined objective. In one example, the predetermined objective may be to predict numerical ratings (e.g., the satisfaction score as shown in FIG. 3) associated with consumer text responses. In another example, the predetermined objective may be to predict problem categories associated with consumer text responses.

In embodiments, the training logic 54 may perform forward propagation through the graph to determine predicted values of the predetermined objective based on the initial weights. For example, if the predetermined objective is numerical ratings, then the training logic 54 may determine predicted values for the numerical rating of each text response node based on the initial weights. If the predetermined objective is problem categories, then the training logic 54 may determine a predicted problem category for each text response node based on the initial weights.

The training logic 54 may then determine a loss function based on a difference between the predicted values of the objective and the actual labeled values of the objective. In particular, as discussed above, the label determination logic 46 may determine labels for each consumer text response (e.g., numerical ratings or problem categories). Thus, the training logic 54 may compare the predicted values of the objective and the labeled values of the objective to determine a loss function based on the initial weights of the graph. The training logic 54 may then perform back propagation to update the weight values to reduce the loss function. These steps may be repeated any number of times to continually update the weights of the edges of the graph to minimize the loss function. Once the loss function is minimized, the updated weights of the edges may be stored as part of the graph parameters 38 in the data storage component 36. The learned weights may indicate which text segments (e.g., which causes, effects, and needs) are most relevant to the predetermined objective.

FIG. 5 shows example weights of a portion of the graph 400 after training by the training logic 54. In the example of FIG. 5, the edge between nodes c1 and t1 has a weight of 0.5, the edge between nodes c2 and t1 has a weight of 0.3, and the edge between node c3 and t1 has a weight of 0.2. This indicates that the text segment associated with node c1 has the strongest correlation to the text response associated with node t1, the text segment associated with node c2 has the second strongest correlation, and the text segment associated with node has the third strongest correlation.

Referring back to FIG. 2, the aggregation logic 56 may aggregate the data of the nodes and the learned weights of the edges between the nodes to display a report or other data presentation to a user. In particular, the aggregation logic 56 may determine which latent components are most relevant to the predetermined objective. For example, the aggregation logic 56 may determine which latent components (e.g., which text segments) are most correlated to a low satisfaction score or particular product categories. The aggregation logic 56 may make this determination based on the edges having the highest weight values after training by the training logic 54. The aggregation logic 56 may then generate a report, such as a list of the most relevant latent components to the objective, and may transmit this report to the user computing device 12a, which may display the report to a user. In some examples, the aggregation logic 56 may generate a graph, summarized text, or other formats to present this information. The information generated by the aggregation logic 56 may comprise extended context derived from the received consumer text responses.

In some examples, a user may specify particular types of information and the aggregation logic 56 may determine the most relevant factors associated with that information based on the weights of the edges connected to a node associated with the specified information. For example, a user may specify particular causes, effects, or needs, particular product attributes, particular demographic information, a particular objective (e.g., specific product categories), and the like. The aggregation logic 56 may determine the edges having the highest weights associated with the nodes having the information specified by the user and present the nodes connected to these edges to the user. This may allow a user to see which factors most affect other factors.

For example, a user (e.g., a business that sent out the consumer surveys) may learn which problem categories most affect certain product models. Alternatively, the user may learn which demographic groups are most likely to report certain problems. In other examples, the user may learn what the most likely cause of certain issues is.

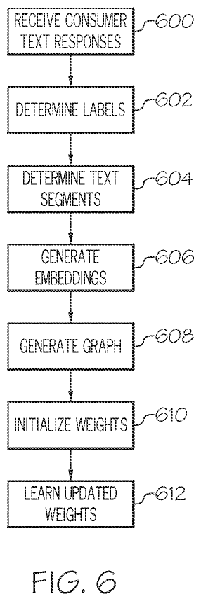

FIG. 6 depicts a flowchart of an example method that may be performed by the server computing device 12b. At step 600, the response reception logic 44 receives consumer text responses. As discussed above, the consumer text responses may include text entered by consumers of a product in response to a survey. In some examples, one or more of the consumer text responses may also include a numerical satisfaction score entered by the consumer that filled out the survey.

At step 602, the label determination logic 46 determines labels for the consumer text responses received by the response reception logic 44. In one example, the labels comprise a numerical satisfaction score input by consumer responding to the surveys. In another example, the labels comprise a problem category, which may be determined by an expert. In other examples, the labels may be related to other objectives.

At step 604, the text segment logic 48 determines text segments for the received consumer text responses using natural language processing techniques. In one example, the text segments may comprise causes, needs, and effects indicated in the text responses.

At step 606, the embedding logic 50 generate embeddings for the text segments identified by the text segment logic 48. In the illustrated example, the embedding logic 50 generates embeddings by determining vector representations of the text segments.

At step 608, the graph generation logic 52 generates a graph comprising a plurality of nodes and edges. One set of nodes may comprise the received consumer text responses. Another set of nodes may comprise the embeddings of the text segments. Other nodes may include product attributes, demographic information, and other information contained in the received consumer text responses. As discussed above, in some examples, the graph generation logic 52 may perform cluster analysis to determine the nodes containing the embeddings of the text segments.

At step 610, the graph generation logic 52 determines initial weights for the edges between the nodes of the graphs, as discussed above. Then, at step 612, the training logic 54 uses a graph neural network to learn updated weights based on the labels determined by the label determination logic 46.

It should now be understood that embodiments described herein are directed to a system and method to generate extended context derived from consumer responses. By determining embeddings of different text segments of consumer text responses, the responses may be numerically analyzed. Furthermore, by learning the weights of the edges between nodes, additional context may be learned about consumer text response. In particular, businesses may learn which issues indicated by consumers lead to lower product satisfaction. As such, businesses may focus their efforts on improving those areas.

In other examples, a business may learn what problems most affect certain product models or certain demographic groups and focus future endeavors on improving the affected models or better marketing to the affected demographic groups. In some examples, using the graph neural network can allow a large set of consumer text responses to be labeled based on having an expert only label a small subset of the consumer text responses, and allowing the weights to be learned to predict the labels for the remaining responses. Thus, the embodiments disclosed herein allow businesses to learn a variety of contextual information about how consumers are using, appreciating, and responding to products. This contextual information may be used to direct resources towards improving products in a way that is most beneficial to customers.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a plurality of consumer text responses;
determining labels for one or more of the consumer text responses;
determining one or more text segments of each of the consumer text responses;
generating an embedding of each of the text segments;
generating a graph comprising a first set of nodes comprising latent components based on the embedding of each of the text segments, a second set of nodes comprising the consumer text responses, and a plurality of edges between the first set of nodes and the second set of nodes;
initializing weights of edges between the first set of nodes and the second set of nodes based on the embedding of each of the text segments; and
using a graph neural network to learn updated weights of the edges based on a predetermined objective.

2. The method of claim 1, wherein the graph further comprises a third set of nodes comprising product attributes associated with the consumer text responses.

3. The method of claim 1, wherein the graph further comprises a third set of nodes comprising demographic information associated with consumers associated with the consumer text responses.

4. The method of claim 1, wherein the one or more text segments comprise one or more of causes, effects, and needs associated with the consumer text responses.

5. The method of claim 1, further comprising:
generating the embedding of each of the text segments by determining a vectorization of each of the text segments using natural language processing.

6. The method of claim 1, further comprising:
determining the one or more text segments based on a linguistic structure of the consumer text responses.

7. The method of claim 1, further comprising:
determining the labels based on numerical ratings associated with the consumer text responses.

8. The method of claim 1, further comprising:
determining the labels based on problem categories determined by an expert.

9. The method of claim 1, further comprising:
determining the latent components by performing cluster analysis on the embeddings of each of the text segments.

10. The method of claim 1, further comprising:
outputting a predetermined number of items of information most relevant to the predetermined objective based on the updated weights.

11. An apparatus comprising one or more processors configured to:
receive a plurality of consumer text responses;
determine labels for one or more of the consumer text responses;
determine one or more text segments of each of the consumer text responses;
generate an embedding of each of the text segments;
generate a graph comprising a first set of nodes comprising latent components based on the embedding of each of the text segments, a second set of nodes comprising the consumer text responses, and a plurality of edges between the first set of nodes and the second set of nodes;
initialize weights of edges between the first set of nodes and the second set of nodes based on the embedding of each of the text segments; and
use a graph neural network to learn updated weights of the edges based on a predetermined objective.

12. The apparatus of claim 11, wherein the graph further comprises a third set of nodes comprising product attributes associated with the consumer text responses.

13. The apparatus of claim 11, wherein the graph further comprises a third set of nodes comprising demographic information associated with consumers associated with the consumer text responses.

14. The apparatus of claim 11, wherein the one or more text segments comprise one or more of causes, effects, and needs associated with the consumer text responses.

15. The apparatus of claim 11, wherein the one or more processors are further configured to:
generate the embedding of each of the text segments by determining a vectorization of each of the text segments using natural language processing.

16. The apparatus of claim 11, wherein the one or more processors are further configured to:
determine the one or more text segments based on a linguistic structure of the consumer text responses.

17. The apparatus of claim 11, wherein the one or more processors are further configured to:
determine the labels based on numerical ratings associated with the consumer text responses.

18. The apparatus of claim 11, wherein the one or more processors are further configured to:
determine the labels based on problem categories determined by an expert.

19. The apparatus of claim 11, wherein the one or more processors are further configured to:
determine the latent components by performing cluster analysis on the embeddings of each of the text segments.

20. The apparatus of claim 11, wherein the one or more processors are further configured to:
output a predetermined number of items of information most relevant to the predetermined objective based on the updated weights.
